(19) United States
(12) Patent Application Publication
(10) Pub. No.: US 2014/0354398 A1
(43) Pub. Date: Dec. 4, 2014

(54) Authenticating and Tracking a Valuable Asset Within the Confines of a Safe

(71) Applicant: International Business Machines Corporation, Armonk, NY (US)

(72) Inventors: Dylan J. Boday, Tucson, AZ (US); Bradford O. Brooks, Longmont, CO (US); Scott W. Pollyea, Loveland, CO (US); Srinivas B. Tummalapenta, Broomfield, CO (US); Ralph E. Wiest, Mount Laurel, NJ (US); Hamza Yaswi, Erie, CO (US)

(73) Assignee: International Business Machines Corporation, Armonk, NY (US)

(21) Appl. No.: 13/905,031

(22) Filed: May 29, 2013

(51) Int. Cl. G07C 9/00

(52) U.S. Cl. CPC G07C 9/00309
USPC 340/5.2

(57) ABSTRACT

An approach is provided to track a hard asset in a smart safe. In the approach, the hard asset is registered with a computing system that is associated with the smart safe. The registration of the hard asset include storing at least one physical attribute of the hard asset in a computer memory. The approach then monitors the presence of the hard asset in the smart safe. If removal of the hard asset is detected, a predefined security action is performed, such as contacting the owner or security personnel.

### TECHNICAL FIELD

The present disclosure relates to an approach that authenticates and tracks a valuable asset within the confines of a safe.

### BACKGROUND OF THE INVENTION

The insurance industry insures billions of dollars in real estate and personal property. In many cases, valuable personal property is stored in a safe at a residence, at a business, or at a bank to ensure that the property is secure. When personal property is secure the insurance companies face little risk since the valuables they are protecting have little chance of being stolen or misplaced. Due to the fact that there is little risk to the insurance company when the valuables are secure, customers of the insurance company can pay a lower rate to insure the item. At present, companies require the person with the insurance policy to notify them if they remove valuables from the secure location, however this type of process is unreliable as insured individuals often fail to report the movement of insured items in and out of the secured location.

### SUMMARY

An approach is provided to track a hard asset in a smart safe. In the approach, the hard asset is registered with a computing system that is associated with the smart safe. The registration of the hard asset include storing at least one physical attribute of the hard asset in a computer memory. The approach then monitors the presence of the hard asset in the smart safe. If removal of the hard asset is detected, a predefined security action is performed, such as contacting the owner or security personnel.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in tracking hard assets within a smart safe;

FIG. 4 is a depiction of a flowchart showing the logic used in registering hard assets stored in the smart safe;

FIG. 5 is a depiction of a flowchart showing the logic used in a user checking a hard asset out of the smart safe; and

FIG. 6 is a depiction of a flowchart showing the logic performed when monitoring the presence of hard assets within the smart safe and taking predefined security actions when a hard asset has been removed without authorization.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

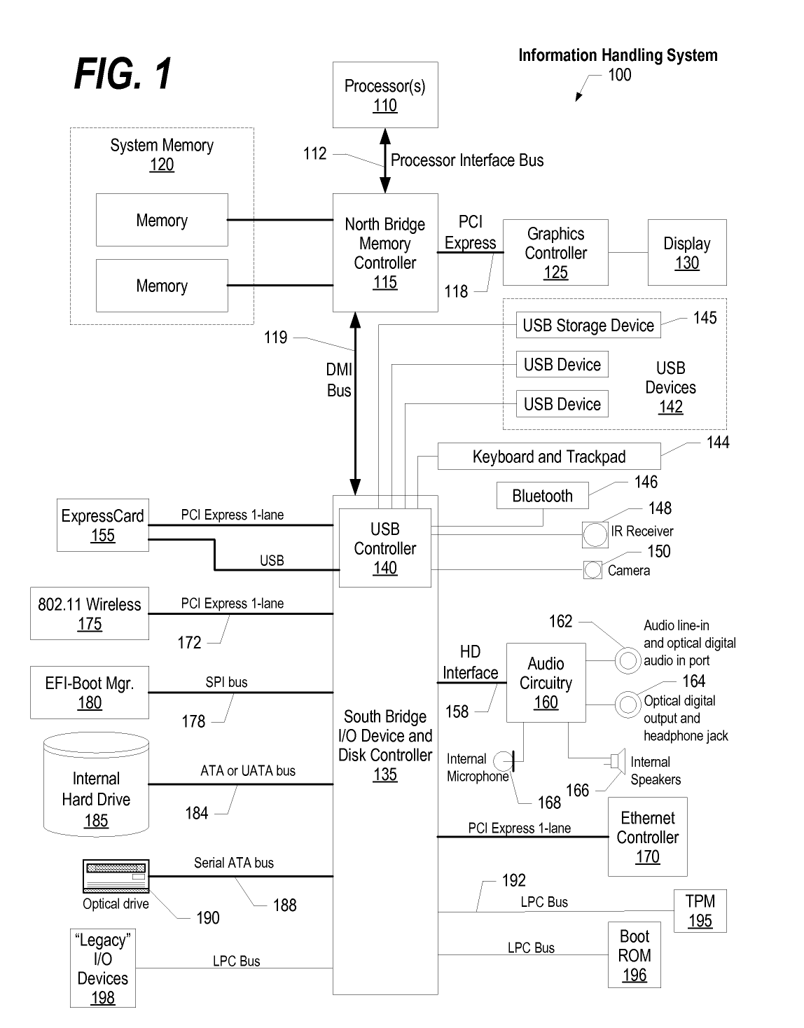

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

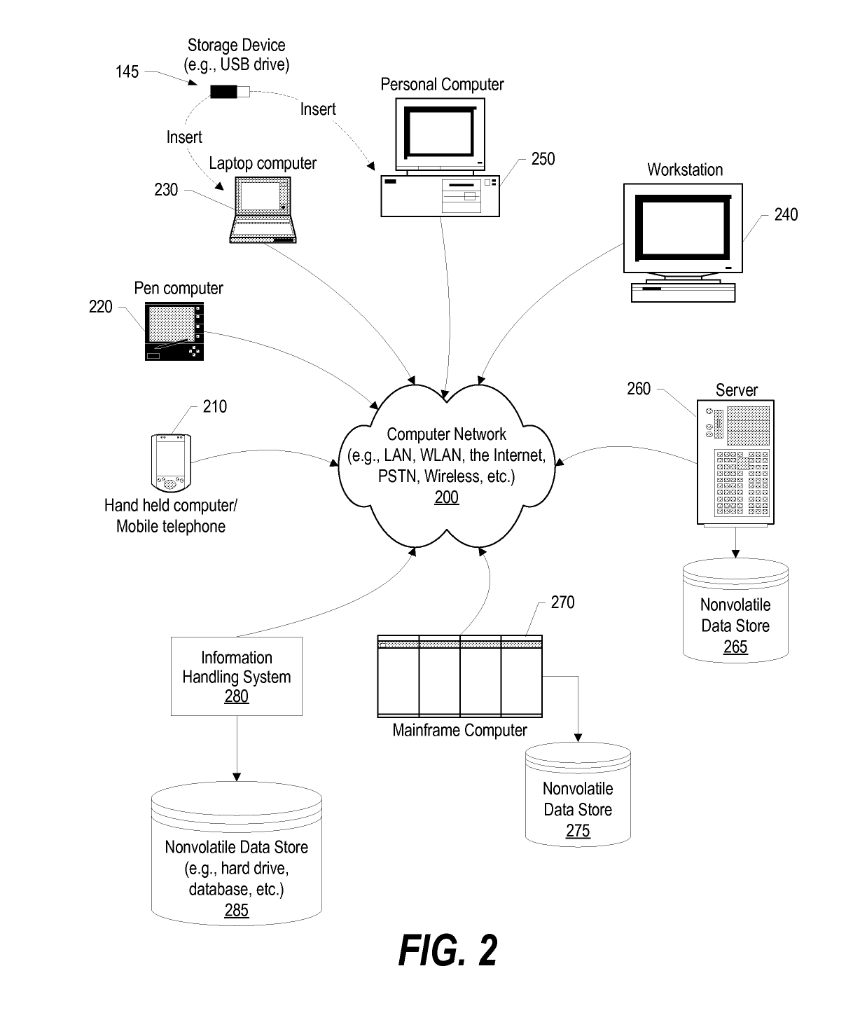

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

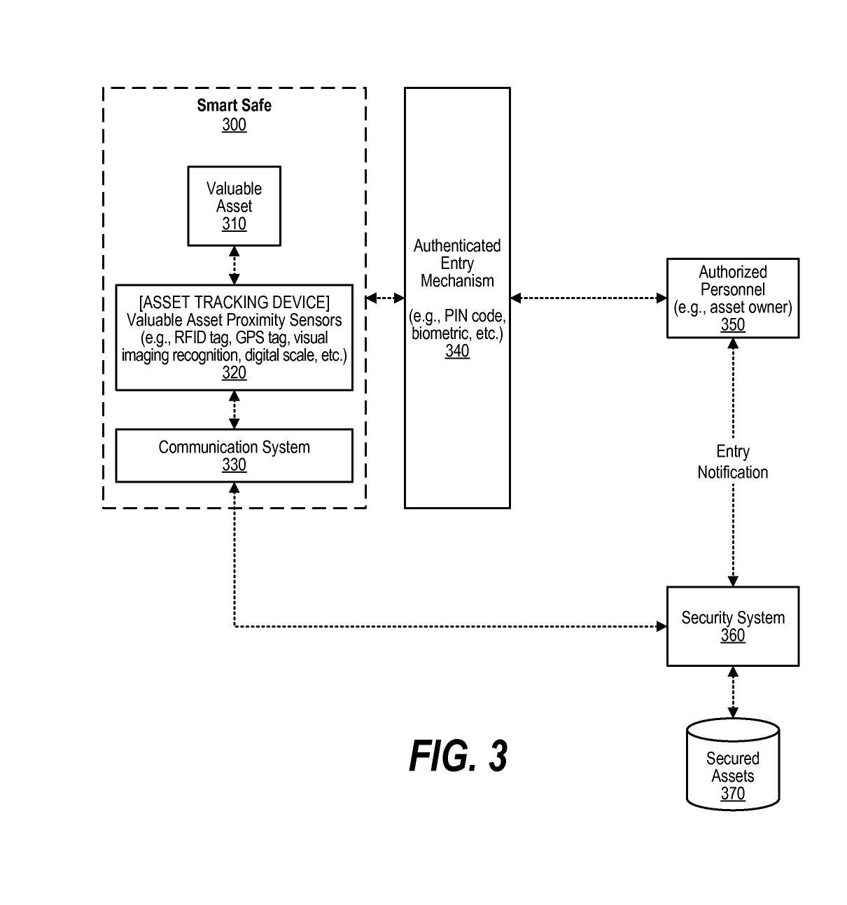

FIGS. 3-6 depict an approach that can be executed on an information handling system, such as a mobile device, and computer network as shown in FIGS. 1-2. A system and method of integrating a smart safe into network which allows for notification to security personnel, such as the insurer or, in the case of possible theft, the owner or police when the hard asset has left the smart safe. Additionally, the smart safe can be fitted with a mechanism, such as sensors, that authenticate the valuable asset and detect when the asset has been returned to the smart safe.

Hard Asset Risk Management (HARM) is a solution and architecture that uses a Smart component and communication mechanisms to track and authenticate hard assets, typically assets of high value. In the approach discussed herein, a system and method is described that tracks and monitors hard asset situated in the smart safe. The smart safe includes communication components that connect via communications technology, such as over a cellular network, via the use of a global positioning system (GPS), using Internet communication using traditional telephone communication, or a communication system with a secure infrastructure.

In one embodiment, a hard asset (e.g. jewelry, art, other valuable asset, etc.) is fitted with a smart component (tracking device) such as RFID, GPS or other technology familiar to those well versed in the art. A tracking device, such as an RFID tag, is another physical attribute of the asset that can be used to determine whether the asset has been moved from the smart safe. This tracking device can be powered by a charge storage device such as a capacitor or battery which is charged via kinetic chargers or RF chargers or other manner known to those familiar with the art. The hard asset imbedded with a tracking device is paired with a communication mechanism such as a mobile phone, GPS, car communication, hard wire, Internet based, a stationary site based communication, a mobile private communication method, or the like that is installed within the smart safe. The communication mechanism and the hard asset would continually, or periodically, communicate with each other to ensure that the hard assets are within the smart safe and, hence, are in the possession of the owner.

The communication device additionally updates a security system, such as a home command center, which is used to verify the relationship and the presence of the hard asset. If the hard asset or smart safe can no longer make connection with the communication mechanism, a signal is sent to a command center to alert authorities of a possible theft attempt. The security system also logs information regarding access to the smart safe, any brute force attempts made to enter the smart safe, and further logs information pertaining to authorized removal of a hard asset and the return of a registered hard asset to the smart safe.

When a new hard asset is added to the smart safe, the asset is registered with the smart safe as well as to the security system. Registration includes gathering physical attributes such as weight, material composition, physical attributes, surface properties, and visual images. During registration, a scale is used to accurately weigh the hard asset and sensors, such as video capture sensors, are used to gather other physical attribute surface properties. Physical attributes of a hard asset include non-tag-related attributes such as weight, material composition, physical attributes, surface properties, and visual images as well as tag-related attributes such as a smart component (tracking device) such as RFID, GPS or other technology familiar to those well versed in the art.

When a hard asset is returned or stored in the smart safe, an authentication procedure is executed to authenticate the person accessing the smart safe. Authentication can include entry of one or more of a password, a biometric data, a key, or a combination. Hard asset detection is based on information included within the security system such as a smart component (tracking device) imbedded within the hard asset or the asset's weight and physical attributes, material composition, refractive index, visual depiction, and surface properties of the hard asset. A Smart Component is a tracking device that can be embedded, attached or coated on a hard asset. The tracking device can store information, transmit information through various communication tools such as a mobile device, a GPS, the Internet, a satellite system, an existing car communication system or via a private communication system with a secure system, mobile private secure communication system. The approach discussed above is further described in FIGS. 3-6 and accompanying detailed descriptions, discussed below, which provide further details related to one or more embodiments that authenticate and track a hard asset within the confines of a smart safe.

FIG. 3 is a component diagram showing the various components used in tracking hard assets within a smart safe. Smart safe 300 is a safe in which hard assets, such as hard asset 310 are stored. Smart safe 300 includes asset tracking device 320 which may be sensors, such as sensors that detect the presence of a tracking device affixed to, applied to, or otherwise included with hard asset 310. In one embodiment, hard asset detection is based on information included within the security system such as a smart component (tracking device) imbedded within the hard asset or the asset's weight and physical attributes, material composition, refractive index, visual depiction, and surface properties of the hard asset. A Smart Component is a tracking device that can be embedded, attached or coated on a hard asset. The tracking device can store information, transmit information through various communication tools such as a mobile device, a GPS, the Internet, a satellite system, an existing car communication system or via a private communication system with a secure system, mobile private secure communication system.

Smart safe 300 further includes communication system 330 which is used to communicate the status of hard assets to security service 360. Security service 360 may be an insurance company that insures hard asset 310, a security monitoring service, a police or sheriffs office, a home-based security command center, or any security-related entity to which hard asset information is communicated. Smart safe 300, using its sensors, monitors the presence of hard asset 310 within the smart safe. When removal of the hard asset is detected, a predefined security action is performed, such as sending a notification or alert through communication system 330 to security service 360. A check-out procedure is included in one embodiment so that the owner can check out hard asset 310 from the smart safe with the check-out procedure notifying security service 360 that the hard asset will be removed by an authorized user (e.g., the hard asset owner, etc.) of the smart safe. In this embodiment, detection of the removal of the hard asset will check whether the hard asset has been checked out by authorized user 350. If the hard asset has not been checked out, the unauthorized removal of hard asset 310 will be communicated by smart safe 300 to security system 360 via communication system 330. For example, in the case where the hard asset is an expensive piece of jewelry that authorized user 350 wishes to wear to a party, the user can check-out the jewelry by notifying security system 360 that the hard asset will be removed from smart safe 300 for a period of time. Authorized user 350 then gains access to smart safe 300 using authenticated entry mechanism 340, such as a password, a biometric data, a key, or a combination lock. As shown, security system 360 maintains data store 370 that details the hard assets being maintained in smart safe 300. When a hard asset is checked out, as described above, the security system makes an entry corresponding to the hard asset. When authorized user 350 subsequently gains access to smart safe 300 and removes the hard asset, such as the expensive jewelry, the smart safe's sensors will detect the removal and notify security system 360 using communication system 330. Security system 360 will check data store 370 to determine whether the hard asset was checked out by an authorized user. If the hard asset was checked out, the security system records the timestamp corresponding to the time/date when the hard asset was removed and, upon return of the hard asset by the authorized user, records a check-in timestamp thereupon recording the total time that the hard asset was outside of the smart safe. Data store 370 may be maintained by an insurance company or may be shared with an insurance company to set insurance rates for the hard assets based upon usage of the hard assets. For example, insurance rates may be lower for a customer of a hard asset that maintains the hard asset in the smart safe than for another customer that routinely removes the hard asset from the smart safe, thus placing the hard asset at greater risk of loss or theft.

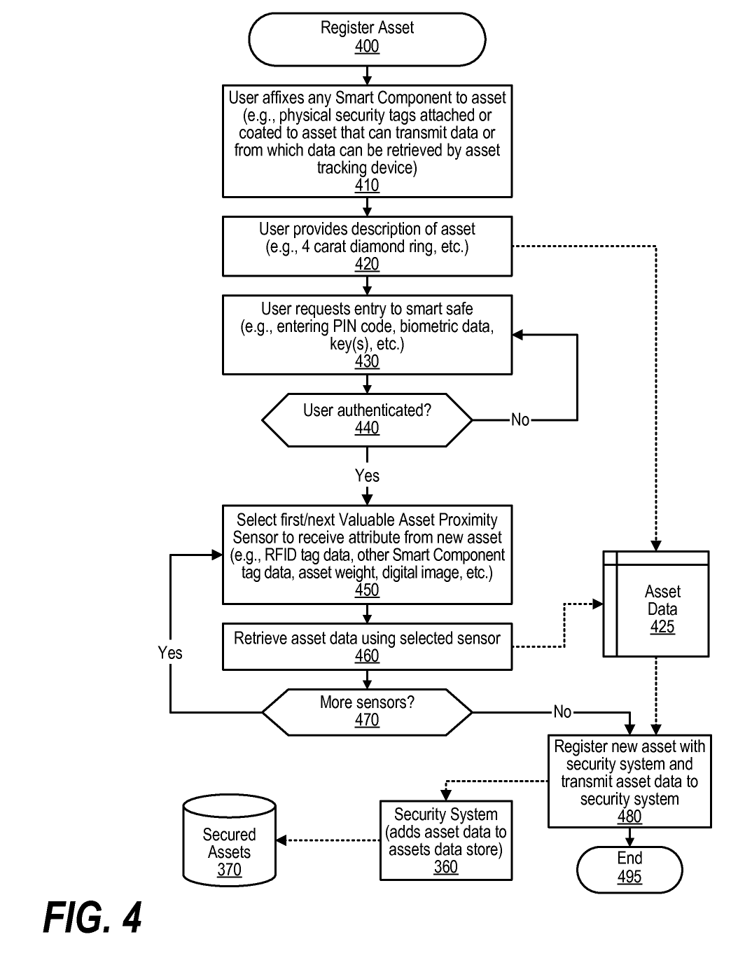

FIG. 4 is a depiction of a flowchart showing the logic used in registering hard assets stored in the smart safe. Registration processing commences at 400 whereupon, at step 410, if used, the user affixes a Smart Component (tracking device) to the hard asset with the tracking device being any physical security tags attached or coated to the hard asset that can transmit data or from which data can be retrieved by an asset tracking device included in the smart safe. At step 420, the user provides a description of the hard asset, such as the hard asset being a four carat diamond ring, etc. The asset description data provided by the user is retained in asset data memory area 425. In one embodiment, this user-provided description is displayed to the user when the user wishes to check-out a hard asset from the smart safe. At step 430, the user requests access to the smart safe by providing authentication data, such as a password, a biometric data, a key, or a combination lock. A decision is made by the system as to whether the authentication data provided by the user is correct (decision 440). If the authentication data is incorrect, then decision 440 branches to the “no” branch which loops back to allow the user to provide a correct set of authentication data. On the other hand, if the authentication data provided by the user is correct and the user is authenticated, then decision 440 branches to the “yes” branch for further registration processing.

At step 450, the process selects the first sensor that is used to detect the presence of the hard asset that is being registered. The selected sensor, such as an RFID tag reader that reads an affixed RFID tag, another Smart Component tag reader that reads another type of tag included with the asset, a scale that accurately weighs the hard asset, a digital image sensor that identifies a visual depiction of the hard asset, a material composition of the asset, a refractive index of the asset, or a surface property of the asset, or the like. At step 460, the asset data gathered by the selected sensor is retrieved and stored in asset data memory area 425. A decision is made as to whether additional sensors included in the smart safe are used to detect the presence of the hard asset within the smart safe (decision 470). If other sensors are used to detect the hard asset's presence within the smart safe, then decision 470 branches to the “yes” branch which loops back to select the next sensor and retrieve corresponding asset data that is again stored in asset data memory area 425. This looping continues until there are no more sensors that are used to detect the presence of this hard asset, at which point decision 470 branches to the “no” branch.

At step 480, the hard asset that is being added to the smart safe is registered with the security system by transmitting the hard asset's data that has been collected in memory area 425 to security system 360. As shown, the security system adds the data pertaining to the hard asset to secured assets data store 370 that is maintained by the security system. Registration processing thereafter ends at 495.

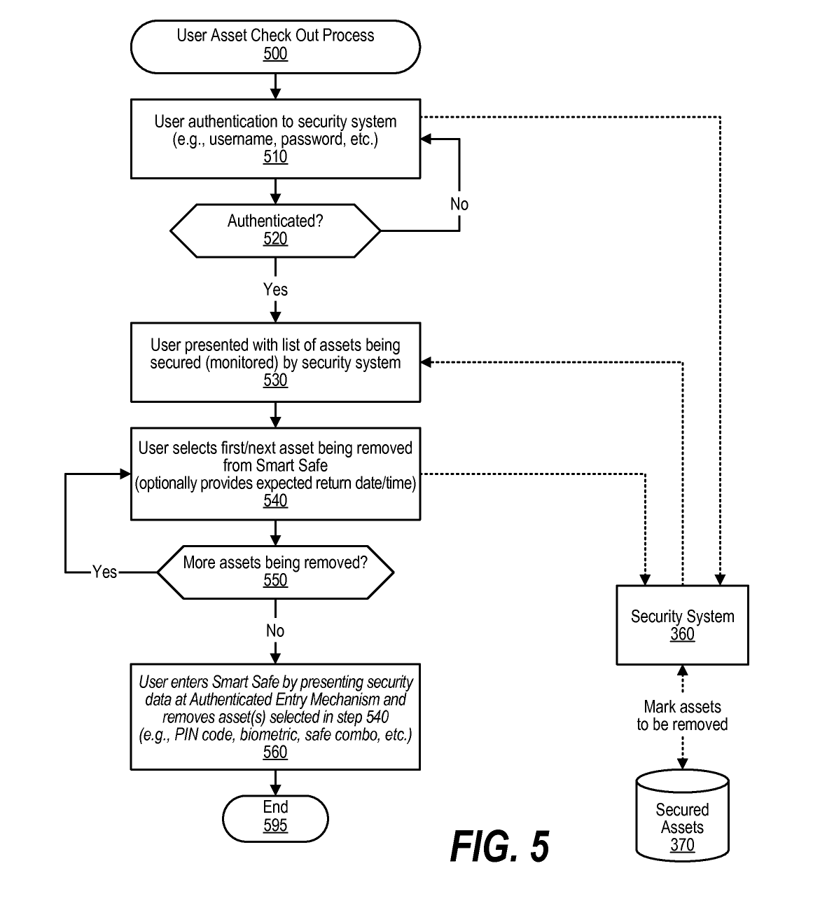

FIG. 5 is a depiction of a flowchart showing the logic used in a user checking a hard asset out of the smart safe. Check out processing commences at 500 whereupon, at step 510, the user requests to check a hard asset out of the smart safe by providing authentication data, such as a password, a biometric data, a key, or a combination lock. A decision is made by the security system as to whether the authentication data provided by the user is correct (decision 520). If the authentication data is incorrect, then decision 520 branches to the “no” branch which loops back to allow the user to provide a correct set of authentication data. On the other hand, if the authentication data provided by the user is correct and the user is authenticated, then decision 520 branches to the “yes” branch for further asset check out processing.

At step 530, the system presents the authenticated user with a list of hard assets currently being monitored in the smart safe. In one embodiment, the list includes the asset descriptions provided by the user when the user first registered the asset with the security system. At step 540, the authenticated user selects the first hard asset that the user will be removing from the smart safe. In one embodiment, the list of assets is presented on a display device, such as a touch screen, from which the user selects the desired asset by touching the asset name/description from the list. Also, in one embodiment, the user can specify an expected return date by providing the date at which the user intends to return the hard asset to the smart safe. For example, if the authenticated user wants to check out an expensive piece of jewelry to wear to a party on a Saturday night, the user might indicate that she expects to return the jewelry to the smart safe sometime on Sunday. In one embodiment, the security system, upon detecting that a hard asset has not been returned to the smart safe by the user-specified check-in date can send the user or owner a reminder to return the hard asset to the smart safe. The hard asset selected by the user for checking out of the smart safe, along with any expected check in date, is transmitted to security system 360. The check out, and future check in, data is used by the security system to update secured assets data store 370 that is maintained by the security system.

A decision is made as to whether the authenticated user wishes to check out any other items from the smart safe (decision 550). If other items are being checked out, then decision 550 branches to the “yes” branch which loops back to receive and process the user's next check out selection as described above. This looping continues until the user has checked out all the desired hard assets, at which point decision 550 branches to the “no” branch. At step 560, the authenticated user enters the smart safe and retrieves the hard assets that have been checked out as described above. The user enters the smart safe by presenting security data at an authenticated entry mechanism that controls access to the smart safe and removes the asset(s) selected in step 540 above. As previously described, access to the smart safe using the authenticated entry mechanism can include entry of one or more of a password, a biometric data, a key, or a combination. Check out processing thereafter ends at 595.

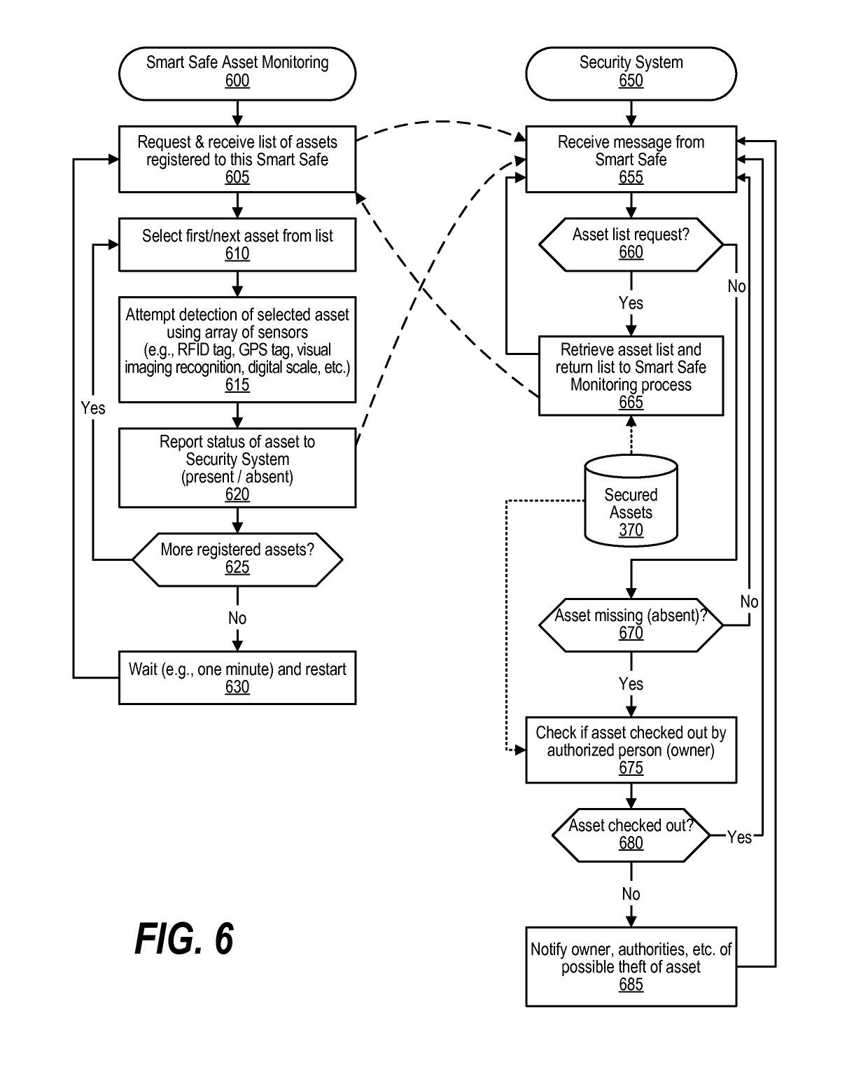

FIG. 6 is a depiction of a flowchart showing the logic performed when monitoring the presence of hard assets within the smart safe and taking predefined security actions when a hard asset has been removed without authorization. Smart safe asset detection processing commences at 600 whereupon, at step 605, the smart safe's processing system requests and receives a list of all of the hard assets currently registered to the smart safe. The list of hard assets registered to the smart safe is requested from the security system using the smart safe's communication system and the security system. At step 610, the smart safe's processing system selects the first hard asset from the list received from the security system. At step 615, the smart safe receives data from its sensors to attempt detection of the selected hard asset in the smart safe. The sensors can include an RFID tag reader that reads an affixed RFID tag, another Smart Component tag reader that reads another type of tag included with the asset, a scale that accurately weighs the hard asset, a digital image sensor that identifies a visual depiction of the hard asset, a material composition of the asset, a refractive index of the asset, or a surface property of the asset, or the like. At step 620, based on data collected by the aforementioned sensors, the smart safe communicates the status of the selected hard asset (e.g., present, absent, etc.). A decision is made as to whether there are additional hard assets that are registered to the smart safe (decision 625). If there are additional hard assets registered to the smart safe, then decision 625 branches to the “yes” branch which loops back to select the next hard asset from the list received from the security system and attempts to detect the asset as described above. This looping continues until all of the hard assets in the list received from the security system have been processed, at which point decision 625 branches to the “no” branch whereupon, at step 630, the smart safe's processing system waits for a period of time (e.g., one minute, ten minutes, an hour, four hours, etc.) before looping back to re-request the list of assets registered to the smart safe and attempting detection of each of the listed assets as described above. Updated lists of assets are requested from the security system in order to include hard assets that may be de-registered by the user as well as hard assets that may be newly registered by the user to the smart safe.

Security system processing is shown commencing at 650 whereupon, at step 655, the security system receives a message, such as a request, from the smart safe's asset detection process. A decision is made as to whether the smart safe is requesting a list of hard assets registered to the smart safe (decision 660). If the message is an asset registration request, decision 660 branches to the “yes” branch whereupon, at step 665, the security system retrieves the list of hard assets registered at the requesting smart safe from secured assets data store 370. The list of hard assets registered to the smart safe are then returned to the requesting smart safe and the security system's processing loops back to receive the next message from a smart safe.

On the other hand, if the message received from the smart safe is not a registered asset request, then decision 660 branches to the “no” branch to process an asset status report received from the smart safe pertaining to an asset registered to the smart safe. A decision is made as to whether the status report indicates that the hard asset is missing, not detected, at the smart safe (decision 670). If the asset is present (not missing), then decision 670 branches to the “no” branch which loops back to receive the next message from a smart safe. On the other hand, if the status report indicates that the hard asset is missing, then decision 670 branches to the “yes” branch whereupon, at step 675, the security system checks secured assets data store 370 in order to ascertain whether an authorized user checked the item out of the smart safe. A decision is made as to whether the hard asset was checked out by an authorized user (decision 680). If the hard asset was checked out by an authorized user, then decision 680 branches to the “yes” branch which loops back to receive the next message from a smart safe. On the other hand, if the hard asset was not checked out by an authorized user, then decision 680 branches to the “no” branch whereupon, a predefined security action is performed. The predefined security action may include notifying the owner of the hard asset, notifying law enforcement authorities, etc. of the possible theft of the hard asset. In one embodiment, the predefined security action may be based on the hard asset that is reported as missing. For example, for an expensive piece of jewelry, the predefined security action might be to notify the owner, law enforcement, and the insurance company, while for an uninsured item, such as an inexpensive handgun, the security action might be to notify the owner and law enforcement. The security system's processing then loops back to receive the next message from a smart safe.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of tracking a hard asset in a smart safe, the method comprising:
registering a hard asset with a computing system associated with the smart safe, wherein the registration comprises storing at least one physical attribute of the hard asset in a computer memory;
monitoring a presence of the hard asset in the smart safe; and
responsive to detecting a removal of the hard asset, performing a predefined security action.

2. The method of claim 1 wherein the predefined security action is an electronic notification transmitted to a security system that informs the security system that the hard asset has been removed from the smart safe.

3. The method of claim 2 further comprising:
periodically attempting detection of the hard asset within the smart safe using one or more sensors, wherein the detection is based on a previously identified physical attribute of the hard asset;
transmitting an electronic notification to a security system, wherein the electronic notification includes a result of the attempted detection; and
responsive to the attempted detection failing to detect the hard asset within the smart safe:
determining whether the electronic notification was received indicating that the hard asset has been removed from the smart safe;
responsive to determining that the electronic notification was not received, performing the predefined security action, wherein the predefined security action is selected from the group consisting of notifying a security agent, notifying a user associated with the hard asset, and triggering a security alarm; and
adjusting an insurance rate associated with the hard asset based upon an amount of time that the hard asset is undetected within the smart safe.

4. The method of claim 1 wherein the hard asset is one of a plurality of hard assets registered with the security system as being within the smart safe, the method further comprising:
monitoring the plurality of hard assets within the smart safe;
detecting an unauthorized removal of a selected one of the hard assets; and
selecting the predefined security action based on an identification of the selected hard asset, wherein the predefined security action is selected from a plurality of predefined security actions.

5. The method of claim 1 wherein the physical attribute is selected from the group of a weight, a material composition, a refractive index, a visual depiction, and a surface property of the hard asset.

6. The method of claim 1 wherein registering further comprises:
associating a technological tracking device with the hard asset, wherein the technological tracking device is a physical attribute of the hard asset with the technological tracking device being included with the hard asset.

7. The method of claim 1 further comprising:
receiving authentication data from a user of the smart safe, wherein the authentication data is selected from the group consisting of a password, a biometric data, a key, and a combination;
retrieving an expected authentication data from a memory area;
authenticating the received authentication data based on the expected authentication data; and
allowing user access to the smart safe in response to a successful authentication.

8. An information handling system comprising:
one or more processors;
a memory coupled to at least one of the processors;
one or more sensors coupled to at least one of the processors, wherein the sensors detect hard assets within a smart safe; and
a set of instructions stored in the memory and executed by at least one of the processors to provide smart safe security, wherein the set of instructions perform actions of:
registering a hard asset that is stored in the smart safe, wherein the registration comprises storing at least one physical attribute of the hard asset in the memory;
monitoring a presence of the hard asset in the smart safe using at least one of the sensors; and
responsive to detecting a removal of the hard asset, performing a predefined security action.

9. The information handling system of claim 8 wherein the predefined security action is an electronic notification transmitted to a security system that informs the security system that the hard asset has been removed from the smart safe.

10. The information handling system of claim 9 further comprising:
periodically attempting detection of the hard asset within the smart safe using one or more sensors, wherein the detection is based on a previously identified physical attribute of the hard asset;
transmitting an electronic notification to a security system, wherein the electronic notification includes a result of the attempted detection; and
responsive to the attempted detection failing to detect the hard asset within the smart safe:
determining whether the electronic notification was received indicating that the hard asset has been removed from the smart safe;
responsive to determining that the electronic notification was not received, performing the predefined security action, wherein the predefined security action is selected from the group consisting of notifying a security agent, notifying a user associated with the hard asset, and triggering a security alarm; and
adjusting an insurance rate associated with the hard asset based upon an amount of time that the hard asset is undetected within the smart safe.

11. The information handling system of claim 8 wherein the hard asset is one of a plurality of hard assets registered with the security system as being within the smart safe, the actions further comprising:
monitoring the plurality of hard assets within the smart safe;
detecting an unauthorized removal of a selected one of the hard assets; and
selecting the predefined security action based on an identification of the selected hard asset, wherein the predefined security action is selected from a plurality of predefined security actions.

12. The information handling system of claim 8 wherein the physical attribute is selected from the group of a weight, a material composition, a refractive index, a visual depiction, and a surface property of the hard asset.

13. The information handling system of claim 8 wherein registering further comprises:
associating a technological tracking device with the hard asset, wherein the technological tracking device is a physical attribute of the hard asset with the technological tracking device being included with the hard asset.

14. The information handling system of claim 8 further comprising:
receiving authentication data from a user of the smart safe, wherein the authentication data is selected from the group consisting of a password, a biometric data, a key, and a combination;
retrieving an expected authentication data from a memory area;
authenticating the received authentication data based on the expected authentication data; and
allowing user access to the smart safe in response to a successful authentication.

15. A computer program product stored in a computer readable medium, comprising computer instructions that, when executed by an information handling system, causes the information handling system to track a hard asset in a smart safe by performing actions comprising:
registering a hard asset with a computing system associated with the smart safe, wherein the registration comprises storing at least one physical attribute of the hard asset in a computer memory;
monitoring a presence of the hard asset in the smart safe; and
responsive to detecting a removal of the hard asset, performing a predefined security action.

16. The computer program product of claim 15 wherein the predefined security action is an electronic notification transmitted to a security system that informs the security system that the hard asset has been removed from the smart safe.

17. The computer program product of claim 16 wherein the actions further comprise:
periodically attempting detection of the hard asset within the smart safe using one or more sensors, wherein the detection is based on a previously identified physical attribute of the hard asset;
transmitting an electronic notification to a security system, wherein the electronic notification includes a result of the attempted detection; and
responsive to the attempted detection failing to detect the hard asset within the smart safe:
determining whether the electronic notification was received indicating that the hard asset has been removed from the smart safe;
responsive to determining that the electronic notification was not received, performing the predefined security action, wherein the predefined security action is selected from the group consisting of notifying a security agent, notifying a user associated with the hard asset, and triggering a security alarm; and
adjusting an insurance rate associated with the hard asset based upon an amount of time that the hard asset is undetected within the smart safe.

18. The computer program product of claim 15 wherein the hard asset is one of a plurality of hard assets registered with the security system as being within the smart safe, and wherein the actions further comprise:
monitoring the plurality of hard assets within the smart safe;
detecting an unauthorized removal of a selected one of the hard assets; and
selecting the predefined security action based on an identification of the selected hard asset, wherein the predefined security action is selected from a plurality of predefined security actions.

19. The computer program product of claim 15 wherein the physical attribute is selected from the group of a weight, a material composition, a refractive index, a visual depiction, and a surface property of the hard asset.

20. The computer program product of claim 15 wherein registering further comprises:
associating a technological tracking device with the hard asset, wherein the technological tracking device is a physical attribute of the hard asset with the technological tracking device being included with the hard asset.
